(19) United States
(12) Patent Application Publication
(10) Pub. No.: US 2023/0058407 A1
(43) Pub. Date: Feb. 23, 2023

(54) Nanobubble Nozzle

(71) Applicant: Alden Research Laboratory, Inc., Holden, MA (US)

(72) Inventors: Kimbal A. Hall, Princeton, MA (US); Sophie A. Waterhouse, Princeton, MA (US)

(21) Appl. No.: 17/820,851

(22) Filed: Aug. 18, 2022

Related U.S. Application Data
(60) Provisional application No. 63/234,405, filed on Aug. 18, 2021.

(51) Int. Cl. B01F 25/312; B01F 23/231; B01F 25/50; B01F 23/2375; B01F 23/237; B01F 35/221; B01F 35/71

(52) U.S. Cl. CPC B01F 25/31241; B01F 23/23121; B01F 25/50; B01F 23/2375; B01F 23/237613; B01F 35/2211; B01F 35/71805

(57) ABSTRACT

A nanobubble nozzle includes a body; an inlet for receiving a liquid; an outlet for discharging the liquid with nanobubbles; a forward channel extending through the body from the inlet to the outlet for transmitting the liquid, the forward channel having a venturi throat; a return channel extending from the outlet to recirculate a portion of the liquid and mix it with a gas to form a two-phase mixture; and an inlet port connecting the return channel to the venturi throat. The liquid flow through the throat creates a suction drawing the two-phase mixture into the throat. A cross-sectional area of the forward channel decreases from the inlet to the throat and increases from the throat to the outlet so that an internal pressure lower than an external pressure outside the body and lower than a vapor pressure of the liquid flowing through the throat is provided at the throat.

### TECHNICAL FIELD

The present teachings relate generally to fluid nozzles or irrigators for pipes, hoses, tubes, or the like. More specifically, the present teachings relate to a nanobubble generating nozzle which mixes a gas with flowing liquid so that the liquid contains nanobubbles.

### BACKGROUND

Nanobubbles are the smallest bubble size known to date. They are at least 100 times, and for example 500 times, smaller than the size of a microbubble. A typical average diameter of a nanobubble is less than 200 nm. At this size scale, much more nanobubbles can fit within the same volume of liquid (e.g., water, aqueous solution, etc.) compared to other bubbles. As a result of their extremely small size, nanobubbles have unique properties associated with neutral buoyancy, strong electric charge, high mass transfer efficiency, long-term stability, and high residence times. These properties enable nanobubbles to provide a superior aeration method for a variety of applications. Nanobubble generation and collapse is also known to create radical oxygen species, which is beneficial for water treatment without the long-lasting harmful side effects of other existing chemical water treatment methods such as chlorination for example.

A bubble nozzle or generator is a device that produces and inserts bubbles into a liquid, and may be configured according to the needs of an end user. In general, the bubble nozzle mixes the liquid with pressurized gas and ejects the liquid with bubbles under reduced pressure. However, conventional nanobubble nozzles or generators are complicated devices having complex structures. For example, some nanobubble generating devices require a high-pressure pump to pressurize the gas, dissolve and reduce the size of the gas bubbles, and/or contain the gas bubbles in the liquid. Other devices further require a rotary vane or blade to produce cavitation. This means that a separate driver or motor is necessary to impart a driving force to the rotary vane, thereby increasing the manufacturing costs and complexity of the device.

Other known nanobubble nozzles or generators utilize porous media direct injection (which involves compressors) or ultrasonic/acoustic cavitation for generating nanobubbles. However, these technologies have drawbacks. WO2011132846 discloses a nozzle which introduces gas into flowing liquid using the porous media direct injection technique. The nozzle includes a body with a passage through which a liquid flows and a nanobubble generating part corresponding to a portion of the passage, wherein a cross-section of the nanobubble generating part becomes small and then large along the flow path so that the nanobubble generating part has an internal pressure lower than an external pressure of the nozzle body. A gas inlet is formed in the nozzle body and connected to the nanobubble generating part so that gas is introduced into the nanobubble generating part due to a difference between the internal pressure and the external pressure. The nozzle of WO2011132846 also includes a dispersing member mounted to the gas inlet to disperse the gas introduced, wherein the dispersing member is formed of a porous material having a diameter smaller than 1 μm. However, porous media direct injection may be limited in the extent of how small bubbles may be generated. There is also unreliability in the way nanobubbles are generated with porous media direct injection. The size of nanobubbles is further influenced by the hydrophilicity of the porous material. The porous material may also become clogged with dust or debris from the air stream, which will change the proportion of air entering the nozzle relative to the water flow, which is an important consideration in how well the nozzle functions.

Thus, there exists a need for an improved nanobubble nozzle or generator that overcomes the above problems in conventional nanobubble nozzles.

### SUMMARY

The needs set forth herein as well as further and other needs and advantages are addressed by the present embodiments, which illustrate solutions and advantages described below.

It is an object of the present teachings to remedy the above drawbacks and shortcomings associated with known nanobubble generating devices.

In particular, it is an object of the present teachings to provide a nanobubble nozzle that requires less complexity in its structural arrangement.

It is a further object of the present teachings to provide a nanobubble nozzle that does not use porous media direct injection or ultrasonic/acoustic cavitation to generate nanobubbles.

These and other objects of the present teachings are achieved by providing a nozzle that generates nanobubbles in a flowing liquid using venturi cavitation. In particular, the present teachings provide a nanobubble nozzle comprising a body having a proximal end and a distal end; an inlet disposed at the proximal end and configured to receive a liquid; an outlet disposed at the distal end and having an aperture for discharging the liquid with nanobubbles; a forward channel extending through the body from the inlet to the discharge outlet for transmitting the liquid, the forward channel having a venturi throat, wherein a cross-sectional area of the forward channel decreases from the inlet to the venturi throat and increases from the venturi throat to the discharge outlet so that an internal pressure is provided at the venturi throat, the internal pressure being lower than an external pressure outside the body and lower than a vapor pressure of the liquid flowing through the venturi throat which causes the liquid to cavitate; a return channel extending from the discharge outlet to recirculate a portion of the liquid and mix it with a gas to form a two-phase mixture; and an inlet port connecting the return channel to the venturi throat, wherein flow of the liquid through the venturi throat creates a suction that draws the two-phase mixture into the venturi throat; wherein a section of the forward channel between the venturi throat and the outlet forms a diffusing region in which the liquid cavitates to form the nanobubbles. In some embodiments, the gas that is injected and mixed with the portion of the liquid to form the two-phase mixture is ozone O₃.

These and other objects of the present teachings are achieved by providing a nozzle system comprising nanobubble nozzle and a gas supply unit in fluid communication with the nanobubble nozzle. The nanobubble nozzle is configured to generate nanobubbles in a flowing liquid using venturi cavitation. The nanobubble nozzle comprises a body having a proximal end and a distal end; an inlet disposed at the proximal end and configured to receive a liquid; an outlet disposed at the distal end and having an aperture for discharging the liquid with nanobubbles; a forward channel extending through the body from the inlet to the discharge outlet for transmitting the liquid, the forward channel having a venturi throat, wherein a cross-sectional area of the forward channel decreases from the inlet to the venturi throat and increases from the venturi throat to the discharge outlet so that an internal pressure is provided at the venturi throat, the internal pressure being lower than an external pressure outside the body and lower than a vapor pressure of the liquid flowing through the venturi throat which causes the liquid to cavitate; a return channel extending from the discharge outlet to recirculate a portion of the liquid and mix it with a gas to form a two-phase mixture; and an inlet port connecting the return channel to the venturi throat, wherein flow of the liquid through the venturi throat creates a suction that draws the two-phase mixture into the venturi throat; wherein a section of the forward channel between the venturi throat and the outlet forms a diffusing region in which the liquid cavitates to form the nanobubbles. The gas supply unit is connected to a gas inlet of the nozzle body, which is configured to feed the gas for forming the two-phase mixture. In some embodiments, the gas supply unit is connected directly to the gas inlet. In other embodiments, a tube, hose, pipe, conduit, channel, or the like, or any combination thereof, may provide the structural connection between the gas inlet of the nozzle body and the gas supply unit. The gas stored and provided by the gas supply unit may be, for example, ozone O₃. In other embodiments, the gas supply unit stores and provides oxygen O₂. In yet other embodiments, the gas supply unit supplies air, nitrogen, or carbon dioxide.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 is a schematic diagram illustrating a nanobubble nozzle according to the present teachings.

FIG. 2 is a cutaway perspective view illustrating the nanobubble nozzle according to the present teachings.

FIG. 3 is an image of a plurality of pressure plates that are each configured for mounting to the nanobubble nozzle according to the present teachings.

FIG. 4 is an image of one embodiment of the nanobubble nozzle according to the present teachings.

FIG. 5 is an image of another embodiment of the nanobubble nozzle according to the present teachings.

FIG. 6 is an exemplary graphical illustration of gas flow (e.g., air flow) considerations that define operation of the nanobubble nozzle according to the present teachings.

FIG. 7 is schematic diagram illustrating a nanobubble system comprising the nanobubble nozzle of FIGS. 1-2 and a gas supply unit connected thereto.

### DETAILED DESCRIPTION

The present teachings are described more fully hereinafter with reference to the accompanying drawings, in which the present embodiments are shown. The following description is presented for illustrative purposes only, and the present teachings should not be limited to these embodiments.

The present teachings have been described in language more or less specific as to structural and mechanical features. It is to be understood, however, that the present teachings are not limited to the specific features shown and described, since the device, apparatus, and/or system herein disclosed comprises preferred forms of putting the present teachings into effect.

For purposes of explanation and not limitation, specific details are set forth such as particular structures, architectures, interfaces, techniques, etc. in order to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

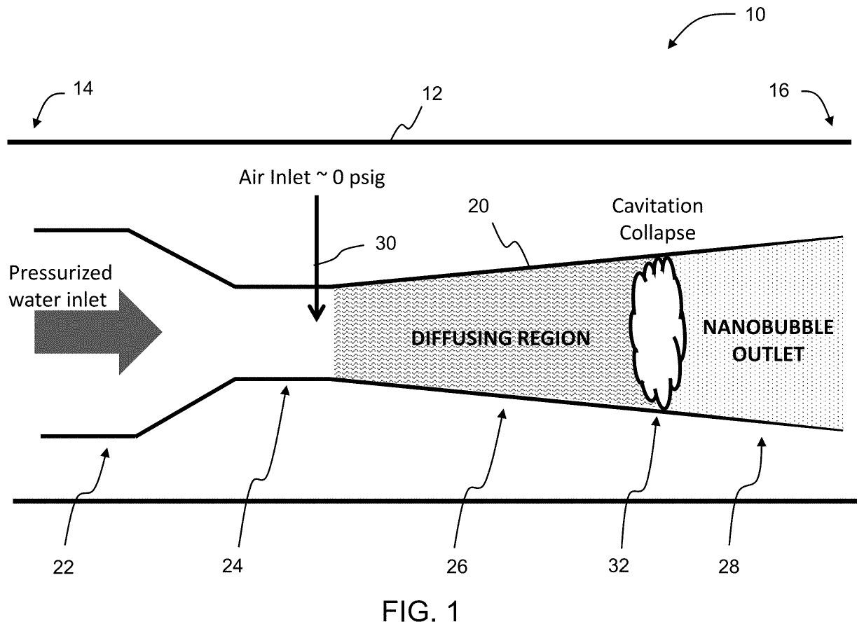

Referring to FIG. 1, it is shown the underlying principle upon which the nanobubble nozzle 10 according to the present teachings generates nanobubbles. The nozzle 10 comprises a body 12 with a forward passage or channel 20 extending through an interior of the body from a proximal end 14 to a distal end 16 (also known as a discharge end). The forward channel 20 comprises at least four main sections, including a fluid inlet 22, and venturi throat 24, a diffusing region 26, and a nanobubble outlet 28. The inlet 22 is located in an area at and/or near the proximal end 14, while the nanobubble outlet 28 is positioned at and/or near the distal end 16. The inlet 22 is configured to receive a flow of liquid (e.g., water, aqueous solution, etc.) and more specifically a flow of pressurized liquid. The inlet is configured to take in a total pressure within a range between 20 psig (gauge pressure) and 100 psig. In one embodiment or application, where a pump(s) supplies the source of liquid (e.g., water) to the nozzle, the inlet 22 is designed to receive 20 to 50 psig. In another embodiment or application, where the nozzle is connected to a municipal/town water source or community water system, the inlet is designed to receive the liquid at an inlet pressure ranging from 20 psig and 100 psig. This broad range helps to accommodate the wide variations in pressure that may be encountered when connected to the municipal/town water source and dependent on the location of the nozzle (e.g., nozzle connected to uphill piping; nozzle connected to downhill piping). In yet other embodiments, the range of inlet pressure may be 20-80 psig, 20-60 psig, 40-100 psig, 60-100 psig, or 40-80 psig. A preferred embodiment of the nozzle, especially when working on municipal water pressure, includes an inlet that is operable to receive approximately 55 psig. Herein, approximately means within a range of +/−10 psig of the defined value. It is noted that the inventors have found that a minimum inlet pressure of at least 20 psig is necessary to achieve cavitation and to generate a reasonable amount of nanobubbles. The flow of liquid received by the inlet 22 may consist of water only in some embodiments, while in other embodiments, the liquid is water with gas bubbles (e.g., air bubbles). The flow of liquid at the inlet has a relative low velocity.

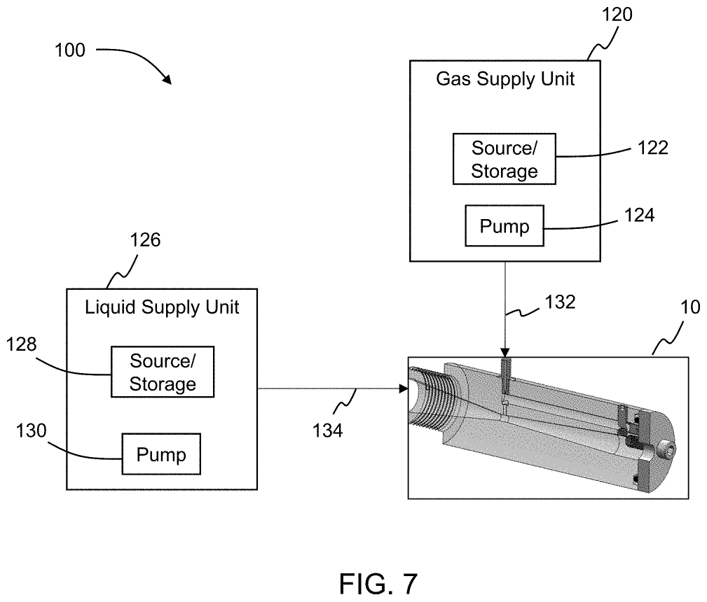

Downstream from the inlet 22 in a distal direction, the cross-sectional area of the forward channel 20 (cross section being perpendicular to a longitudinal axis of the forward channel) reduces towards the venturi throat 24. In a preferred embodiment, the forward channel 20 tapers and decreases gradually in size to the throat 24. The reduction in the cross-sectional area of the forward channel causes the pressure of liquid flow to drop to the extent that the static pressure of the liquid within the throat is less than or equal to 0.3 psia (absolute pressure). More specifically, the liquid vapor pressure at its incoming temperature is around 0.3 psia for water at 20° C. It is noted, however, that the throat may be configured to withstand pressures higher or lower than 0.3 psia. In the area of the throat 24, the nozzle body has a gas inlet 30, which is in fluid communication with the throat of the forward channel. The gas inlet, in some embodiments, is an air inlet which receives air from the atmosphere surrounding the nozzle or other gaseous source. In some embodiments, the gas inlet receives ozone O₃, oxygen O₂, nitrogen N₂, carbon dioxide CO₂, or some other gas, from a gas supply unit 120 (FIG. 7). The gas inlet 30 is designed to transmit the gas at approximately 0 psig (ambient pressure), but may be anywhere between the vapor pressure of the liquid and the supply pressure of the liquid. Accordingly, at this point, the liquid in the forward channel is mixed with gas, thereby creating bubbles (e.g., air bubbles, ozone bubbles). The flow of liquid in the throat also has a very high velocity due to the decrease in cross-sectional area of the forward channel 20. As shown in FIG. 1, the throat maintains substantially a constant size (i.e., diameter).

At the downstream end of the venturi throat 24, the forward channel 20 begins to increase in size (i.e., diameter), preferably by a gradual expansion. Cavitation begins in this portion of the forward channel, known as the diffusing region 26. Within the diffusing region, the liquid (e.g., water) cavitates and/or boils, creating vapor bubbles in the liquid. The static pressure of the liquid still has a static pressure of less than or equal to the liquid vapor pressure. The diffusing region is characterized by a high and increasing void faction (air+vapor; ozone+vapor), and the velocity of the liquid flow within the diffusing region is also very high. In some embodiments, the diffusing region 26 may be longer (in the longitudinal direction of the nozzle) than the length of the inlet 22 and the length of the throat 24 individually. The diffusing region, in other embodiments, may be longer than the combination of the inlet and the throat. The extent in which cavitation occurs in the diffusing region, i.e., the length of the diffusing region where cavitation is generated, is dependent on inlet conditions. For example, higher inlet pressures result in a longer diffusing region.

As shown in FIG. 1, there is cavitation collapse 32 in an area of the forward channel 20 within the diffusing region 26 and before the nanobubble outlet 28 begins. The locally high pressure and temperature generated by cavitation collapse of vapor bubbles breaks up the gas bubbles (e.g., air bubbles, ozone bubbles, oxygen bubbles) into nanobubbles, and is also responsible for generation of radical oxygen species. The cavitation collapse occurs at different axial locations within the diffusing region 26 depending on the inlet pressure. For example, with lower inlet pressures, cavitation collapse is closer to the upstream end of the diffusing region (i.e., closer to the venturi throat) because there is not enough energy for cavitation to last to the downstream end of the diffusing region. On the other hand, with higher inlet pressures, there is more energy which means that cavitation lasts longer within the diffusing region and cavitation collapse is closer to the downstream end of the diffusing region (i.e., closer to the nanobubble outlet). The portion of the diffusing region 26 downstream from the cavitation bubble collapse helps to recover pressure as described above. With a longer cavitation zone (higher inlet pressure), more of the input energy is put into nanobubble generation, and higher gas flow rates can be accommodated.

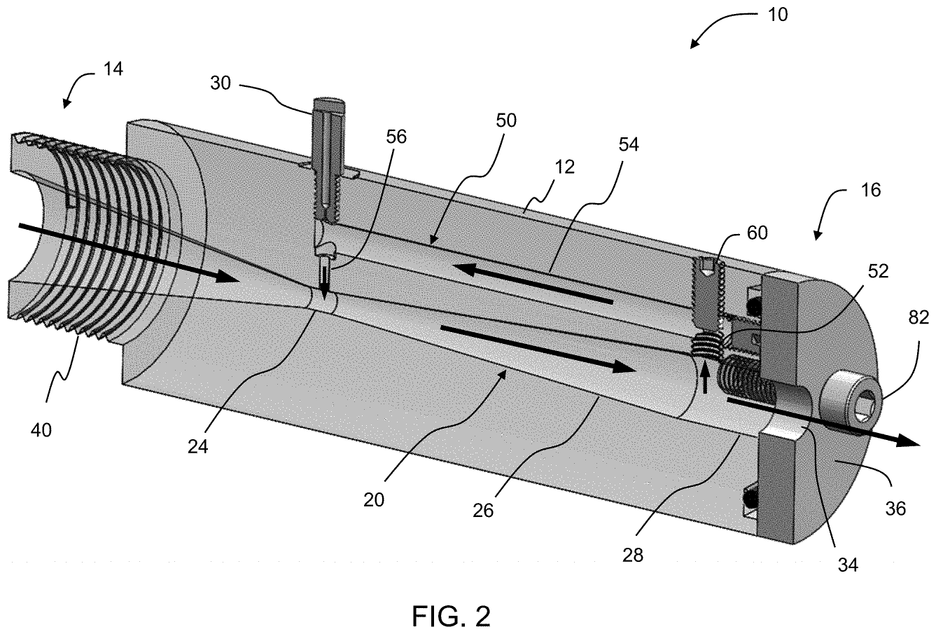

Downstream of the cavitation collapse, the nanobubble outlet 28 provides an opening or aperture 34 (FIG. 2) that discharges or ejects the liquid containing nanobubbles. In some embodiments, the nanobubble outlet 28 continues to expand (e.g., with increasing channel diameter or width), converting kinetic energy to potential energy (pressure), thereby enabling the nozzle to be more energy efficient. The discharge end of the nozzle body 12 may include a pressure plate 36 mounted thereto. The pressure plate 36 may be detachably mounted to the nozzle body, so that different pressure plates (having different properties or characteristics, such as pressure ratings) can be releasably attached to satisfy the needs of a particular application. The nanobubble outlet 28 discharges the liquid with nanobubbles to approximately 0 psig (gauge pressure). Approximately here means within a range of +/−5 psig of the defined value. Within this section of the forward channel, there is pressure recovery in diffuser. The outlet diameter of the nanobubble outlet 28 (e.g., diameter of aperture 34) is set by the desired jet velocity. In some embodiments, instead of a pressure plate mounted to the nozzle body, the distal end of the nozzle body is connectable to one or more downstream pipes. This means that the nozzle may be inserted in between pipes and need not be disposed at the terminal end of a piping system.

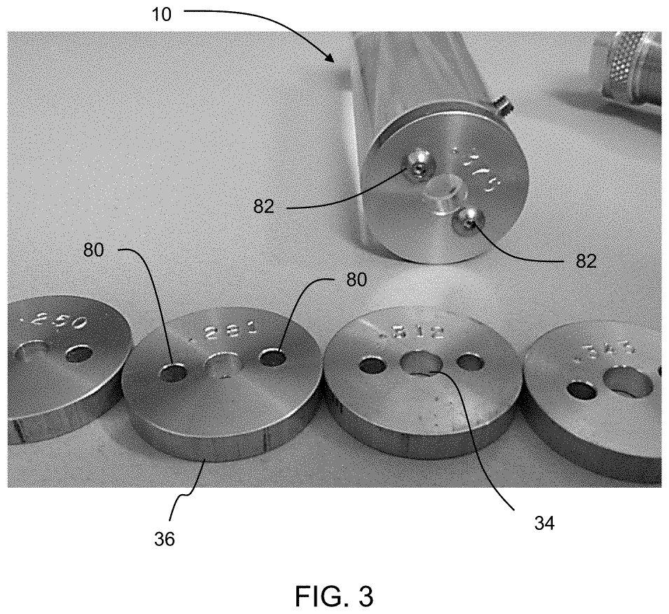

As shown in FIG. 3, a plurality of pressure plates 36 are shown. Each pressure plate is configured to fasten or mount to the distal end (i.e., the discharge end) of the nanobubble nozzle. Each pressure plate 36 is designed to withstand a different level of pressure that may be exerted by the nanobubble-containing liquid as it is discharged from the nozzle opening 34. This allows for the nanobubble nozzle to be adaptable to different applications and/or the needs of the end user. As shown, each pressure plate includes at least two fastening apertures 80 each designed to receive a fastener 82 (e.g., screw, bolt, nut, etc.) In addition, the pressure plates may provide nozzle openings with different sizes (i.e., diameter), thereby allowing for the nanobubble nozzle to be easily adapted to different applications. Pressure loss from downstream lengths of pipe may also serve the same purpose as the pressure plates.

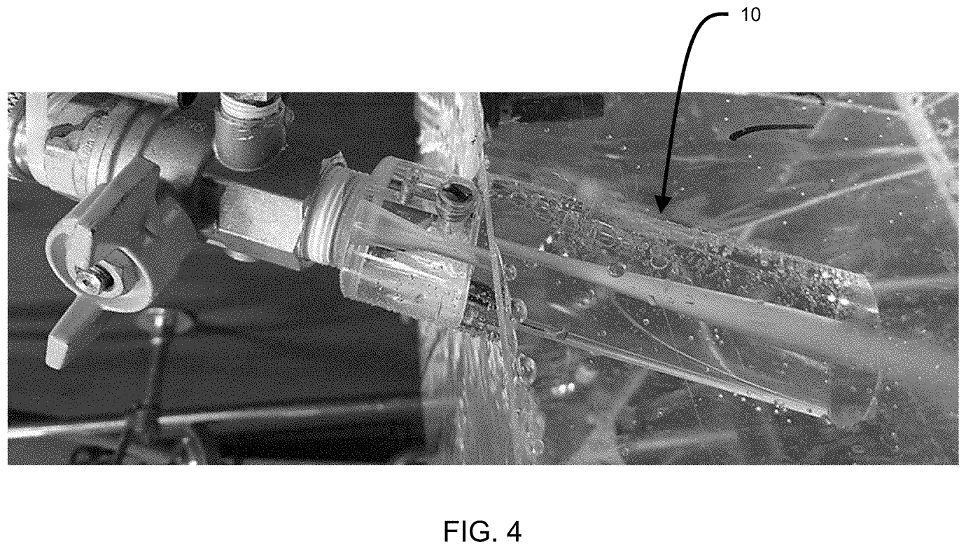

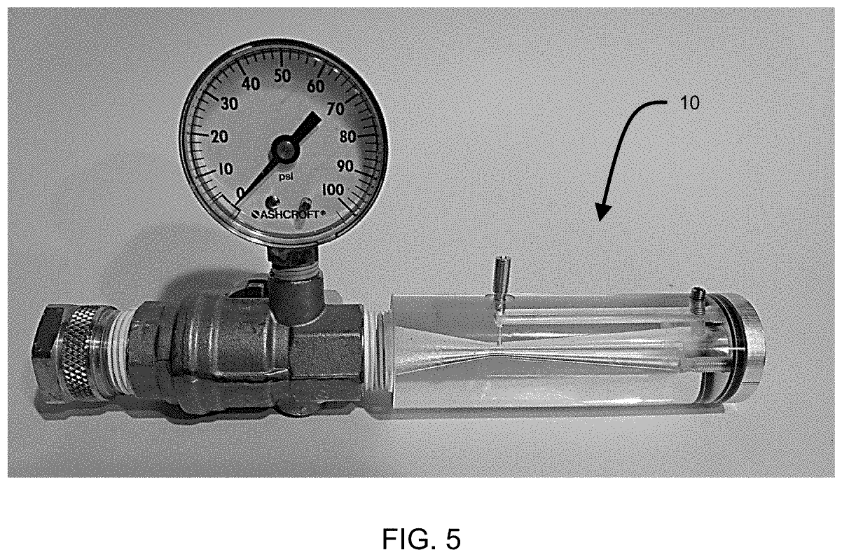

Referring to FIG. 2, the proximal end 14 of the nozzle body has a fastener or fastening mechanism 40 for releasably attaching the nozzle 10 to a pipe, hose, tube, or the like. The fastener 40 may comprise a male connector with threads (e.g., ¾″ NPT) that are configured to be inserted into and engage with a threaded female connector. However, in other embodiments, a reverse configuration may be present, where the fastener 40 comprises a threaded female connector that engages with a male connector. FIGS. 4-5, for example, show the proximal end 14 of the nozzle body 12 releasably connected to a pressure gauge, which in turn is connectable to a water pipe or hose. The interior of the fastener 40 includes a passage which forms a part of the pressurized liquid inlet 22 (approximately 20 psig).

The nozzle 10 according to the present teachings also comprises a closed-loop feedback 50. This closed-loop feedback includes an exit port 52 positioned at and connected with (i.e., in fluid communication) the nanobubble outlet 28. The exit port 52 is preferably arranged at or substantially near the distal (downstream) end of the nanobubble outlet 28. The exit port 52 should be located downstream of the cavitation collapse 32. The closed-loop feedback 50 also includes a return channel 54 connected to the port 52. In some embodiments, the return channel is substantially parallel with the longitudinal axis of the forward channel 20. However, in other embodiments, the return channel may be arranged in a non-parallel manner, such that it either converges towards or diverges away from the longitudinal axis of the forward channel. The size (diameter) of the return channel 54 may remain constant from one end to an opposing end thereof. The closed-loop feedback 50 further includes an inlet port 56 connecting the return channel 54 to the venturi throat 24 of the forward channel 20. By way of the exit port 52, return channel 54, and the inlet port 56, liquid is recirculated from the venturi outlet back to the throat 24.

The gas inlet 30 (e.g., air inlet) is connected to the return channel 54 and/or the inlet port 56. FIG. 2, for example, shows that the gas inlet is disposed at the end of the return channel 54, which feeds into the inlet port 56. As a result, the gas inlet transmits a gas from the surrounding atmosphere (e.g., ambient air) or other type of gas reservoir (e.g., ozone) into the closed-loop feedback 50 and mixes the gas with the recirculating liquid. This mixture of gas and water is then injected into the venturi throat 24 via the inlet port 56. This particular arrangement utilizes the density of the recirculating liquid to throttle the gas flow (from the gas inlet), thereby enabling a larger hole to be used at the inlet port 56. In some embodiments, the gas inlet 30 comprises a motorcycle pilot jet with approximately 1/64″ diameter. In other embodiments, the gas inlet 30 may contain an operable or manually adjustable valve.

As shown in FIG. 2, both the exit port 52 and the inlet port 56 have axes that are substantially perpendicular to the longitudinal axis of the forward channel 20. However, the scope of the present teachings includes a nozzle configuration where one or both of the exit port and the inlet port intersect the forward channel at an angle other than 90°.

A throttling valve 60 may be disposed at the exit port 52 to control the flow of liquid that is recirculated through the return channel 54. By adjusting the throttling valve 60, the flow rate and pressure of the recirculating liquid can be changed/regulated.

FIGS. 4-5 show different embodiments of the nanobubble nozzle. FIG. 4, in particular, depicts a garden hose style nozzle that ejects a flow of liquid with nanobubbles contained therein. FIG. 5 shows the interior of a garden hose style nozzle body comprising the structural elements described above that are designed to provide venturi cavitation for generating and inserting nanobubbles into the flowing liquid. In the garden hose nozzle application, there is plenty of water pressure from the municipal water supply to create the cavitation required for generating nanobubbles. Since the nozzle is able to cavitate, then there exists the low pressure necessary to suction the gas (from surrounding atmosphere) into the venturi throat 24.

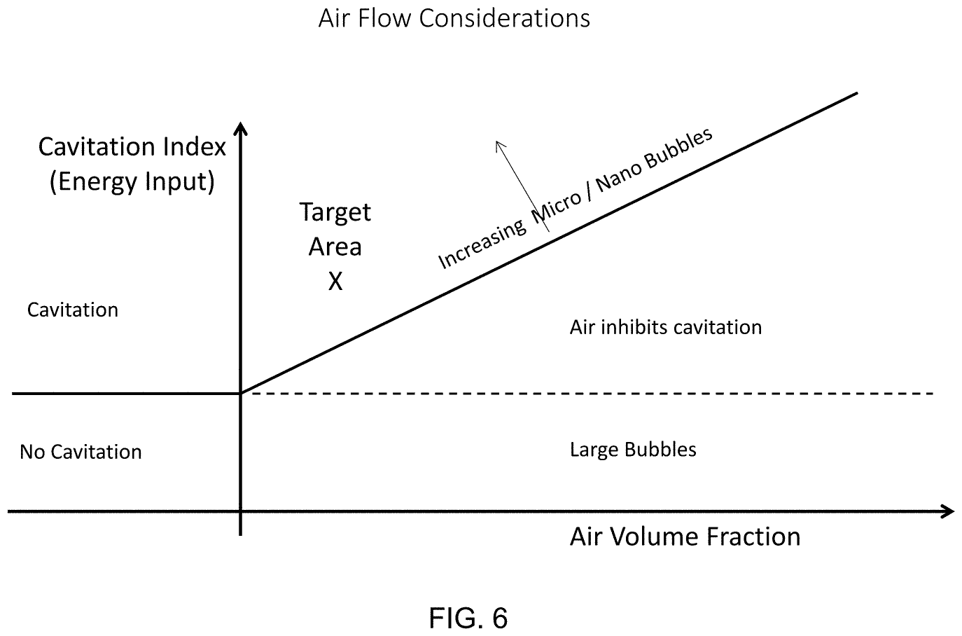

FIG. 6 shows gas flow (e.g., air flow) considerations of the nozzle according to the present teachings. These gas flow considerations may be represented by a graph of gas volume fraction versus inlet pressure. With the closed-loop feedback 50 and the injection of a two-phase (liquid-gas) mixture at the venturi throat 24 (via the inlet port 56), there is a target area for achieving optimal generation of nanobubbles, where the inserted gas does not inhibit cavitation. The pressure differential between atmospheric pressure and water vapor pressure is high (14.5 psi). If there is too much gas flow, cavitation is inhibited. With high differential pressure and low flow, an extremely small hole would be required at the gas inlet 30 and the inlet port 56. However, an extremely small hole would be disadvantageous because it would be difficult to make and would be prone to clogging (by minerals, dirt, debris, etc. found in municipal water). To resolve this issue and utilize a larger hole at the inlet port 56, the present teachings utilize the increased density of a two-phase gas/liquid mixture to regulate the air flow rate. Various pilot jet sizes may be used to control air flow, providing coarse adjustments. The throttling valve 60, on the other hand, adjusts the liquid-gas mixture, providing fine adjustment. When the throttling valve is fully closed, then there is 100% air flow. On the other hand, there is 0% air flow when the throttling valve is fully open. Furthermore, a plurality of pressure plates 36 with sizes ranging from 0.375″ to 0.250″ bore hole diameter may also provide coarse adjustment. Different pressure plates may be used for different inlet pressure ranges. Additionally, as described above, the density of the recirculating liquid helps to produce a pressure drop, which in turn enables for a larger hole to be used at the inlet port 56. For example, the diameter of the inlet port 56 may be as large as ½ the diameter of the venturi throat 24.

FIG. 7 shows a nanobubble system 100 comprising the nanobubble nozzle 10 as described above, a gas supply system or unit 120 in fluid communication with the gas inlet 30 of the nozzle body 12, and a liquid supply system or unit 126 in fluid communication with the liquid inlet 22 of the nozzle body 12. The gas supply unit 120 may comprise a gas source, storage or reservoir 122 for storing the gas (e.g., ozone, oxygen, air) prior to being conveyed to the gas inlet 30. In some embodiments, the gas supply unit 120 may include a pump 124 to transmit the gas to the gas inlet 30. The gas supply unit 120 may be connected directly to the gas inlet 30, or alternatively, may be connected via a tube, hose, pipe, conduit, channel, or the like 132.

The liquid supply unit 126 may comprise a liquid source, storage or reservoir 128 for storing the liquid prior to being conveyed to the liquid inlet 22. In some embodiments, the liquid supply unit 126 may include a pump 130 to transmit the liquid (e.g., water) to the liquid inlet 22. The liquid supply unit 126 may be connected directly to the liquid inlet 22, or alternatively, may be connected via a tube, hose, pipe, conduit, channel, or the like 134. In some embodiments, the liquid supply unit 126 may simply be a municipal or city water system.

According to the present teachings, the two-phase liquid-gas mixture can be introduced into the low-pressure venturi throat in any one or more of the following ways: (1) single injection point as shown in FIGS. 1-2; (2) multiple injection points around the perimeter of the venturi throat; (3) using an annular gap around the perimeter of the venturi throat; (4) using a perforated or porous material for the venturi throat wall to introduce the gas evenly; (5) using a thin tube/pipe located at the centerline of the venturi throat.

The nozzle body according to the present teachings is designed to be used in various applications, and for example, can be used on municipal water supply lines (i.e., with municipal water pressure ranging between 20-100 psi). Due to the various features and characteristics of the nozzle 10, nanobubble generation is achieved without need of a compressor, pump, or porous medium. A person of ordinary skill in the art will recognize that this to a major advantage of the present invention over conventional nanobubble generators, which require separate equipment.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of any claims and their legal equivalents, as understood by those of skill in the art relying upon the disclosure in this specification and the attached drawings.

What is claimed:

1. A nanobubble nozzle comprising:
a body having a proximal end and a distal end;
an inlet disposed at the proximal end and configured to receive a liquid;
an outlet disposed at the distal end and having an aperture for discharging the liquid with nanobubbles;
a forward channel extending through the body from the inlet to the outlet for transmitting the liquid, the forward channel having a venturi throat, wherein a cross-sectional area of the forward channel decreases from the inlet to the venturi throat and increases from the venturi throat to the outlet so that an internal pressure lower than an external pressure outside the body and lower than a vapor pressure of the liquid flowing through the venturi throat is provided at the venturi throat;
a return channel extending from the outlet to recirculate a portion of the liquid and mix it with a gas to form a two-phase mixture; and
an inlet port connecting the return channel to the venturi throat, wherein flow of the liquid through the venturi throat creates a suction that draws the two-phase mixture into the venturi throat;
wherein a section of the forward channel between the venturi throat and the outlet forms a cavitation zone in which the liquid cavitates to form the nanobubbles.

2. The nanobubble nozzle of claim 1, wherein the two-phase mixture is a liquid-gas mixture.

3. The nanobubble nozzle of claim 1, wherein the gas is ozone.

4. The nanobubble nozzle of claim 1, further comprising a gas inlet connected to the return channel and configured to provide a flow of gas from outside the body into the return channel.

5. The nanobubble nozzle of claim 4, wherein the gas inlet comprises a valve to control the flow of gas and regulate inlet pressure.

6. The nanobubble nozzle of claim 5, wherein the gas inlet is a pilot jet or a small orifice.

7. The nanobubble nozzle of claim 1, further comprising an exit port connecting the return channel to the outlet, the exit port being configured to transmit the portion of the liquid for recirculation.

8. The nanobubble nozzle of claim 7, further comprising a throttle valve disposed at the exit port, the throttle valve being configured to regulate a flow of the portion of the liquid for recirculation.

9. The nanobubble nozzle of claim 1, further comprising a pressure plate attached to the distal end of the body, the pressure plate comprising said aperture for discharging the liquid with nanobubbles.

10. The nanobubble nozzle of claim 9, wherein the pressure plate is releasably attached to the distal end of the body via one or more fasteners.

11. The nanobubble nozzle of claim 1, wherein the outlet is connectable to one or more downstream pipes such that the liquid with nanobubbles is discharged into said one or more downstream pipes.

12. The nanobubble nozzle of claim 1, wherein the body comprises a threaded connector at the proximal end of the body, the threaded connector having an interior passage that forms a proximal portion of the forward channel, and
wherein the threaded connector is configured to connect to a pipe, hose, or tube.

13. A nanobubble system comprising:
a nozzle including:
a body;
an inlet configured to receive a liquid;
an outlet configured to discharge the liquid with nanobubbles;
a forward channel extending through the body from the inlet to the discharge outlet for transmitting the liquid, the forward channel having a venturi throat, wherein a cross-sectional area of the forward channel decreases from the inlet to the venturi throat and increases from the venturi throat to the discharge outlet so that an internal pressure lower than an external pressure outside the body and lower than a vapor pressure of the liquid flowing through the venturi throat is provided at the venturi throat;
a return channel extending from the discharge outlet to recirculate a portion of the liquid and mix it with a gas to form a two-phase mixture; and
an inlet port connecting the return channel to the venturi throat, wherein flow of the liquid through the venturi throat creates a suction that draws the two-phase mixture into the venturi throat;
wherein a section of the forward channel between the venturi throat and the outlet forms a cavitation zone in which the liquid cavitates to form the nanobubbles;
a gas supply unit in fluid communication with the return channel to provide said gas to form the two-phase mixture.

14. The nanobubble system of claim 13, wherein the gas supply unit provides ozone as the gas.

15. The nanobubble system of claim 13, wherein the nozzle further comprises a gas inlet connecting the gas supply unit to the return channel.

16. The nanobubble system of claim 15, wherein the gas inlet comprises a valve to control the flow of gas and regulate inlet pressure.

17. The nanobubble system of claim 13, wherein the nozzle further comprises an exit port connecting the return channel to the outlet, the exit port being configured to transmit the portion of the liquid for recirculation.

18. The nanobubble system of claim 17, wherein the nozzle further comprises a throttle valve disposed at the exit port, the throttle valve being configured to regulate a flow of the portion of the liquid for recirculation.

19. The nanobubble system of claim 13, further comprising a liquid supply unit in fluid communication with the inlet of the nozzle.

20. The nanobubble system of claim 19, further comprising a pipe, hose, or tube having a proximal end connected to the liquid supply unit and a distal end connected to a proximal end of the nozzle body via a threaded coupling, wherein the threaded coupling has an interior passage that forms a proximal portion of the forward channel.
